(19) United States
(12) Patent Application Publication
(10) Pub. No.: US 2008/0178047 A1
(43) Pub. Date: Jul. 24, 2008

(54) Software Test System, Method, And Computer Readable Recording Medium Having Program Stored Thereon For Executing the Method

(75) Inventors: Hyun Seop Bae, Seoul (KR); Gwang Sik Yoon, Seoul (KR); Seung Uk Oh, Gyeonggi (KR)

Correspondence Address: WOLF, BLOCK, SHORR AND SOLIS-COHEN LLP, 250 PARK AVENUE, 10TH FLOOR, NEW YORK, NY, 10177, US

(73) Assignee: Suresoft Technologies Inc., Seoul (KR)

(21) Appl. No.: 12/015,570

(22) Filed: Jan. 17, 2008

(30) Foreign Application Priority Data
Jan. 19, 2007 (KR) 10-2007-0006102

(51) Int. Cl. G06F 11/00

(52) U.S. Cl. 714/38; 714/E11.001

(57) ABSTRACT

A software test system includes: a terminal device in which software to be tested is installed; and a software test device that stores a test driver for testing the test-target software according to test data and a test procedure of the test-target software, wherein the test driver is transmitted to the terminal device and tests the test-target software by combining the test data and the test procedure within the terminal device. A test-target program can be tested within a short time at a relatively low cost, and the reliability of the testing can be improved.

### RELATED APPLICATIONS

This Nonprovisional application claims priority under 35 U.S.C. §119(a) on Patent Application No. 10-2007-0006102 filed in Korea on Jan. 19, 2007, the entire contents of which are hereby incorporated by reference.

### BACKGROUND OF THE INVENTION

1. Field of the Invention

The present invention relates to a software test system, method and a computer-readable recording medium having a program stored thereon for executing the method.

2. Description of the Related Art

Software testing is a process of verifying whether or not software satisfies stipulated requirements, and executing and evaluating the entirety or some of elements of a software system to recognize a difference between anticipated results and actual results.

For instance, in the process of developing mobile communication terminals such as mobile phones, smart phones, PDA (Personal Digital Assistants), and the like, developers should test whether software equipped in their developed terminals operates properly or not by actually interworking (cooperatively operating) with a wireless communication system. If an error is discovered in the test process, a cause of the error is analyzed to find a solution to correct the error.

The related art software testing method performs testing on software using only prepared test cases.

The test cases include test scripts and test data. That is, scripts for testing and the test data are all set before testing the software.

Thus, according to the related art software testing method, because the test data is set, even if testing is not sufficient or an incomplete part is discovered after running a test, the insufficient testing or the incomplete part cannot be supplemented. That is, after the testing is completed, new test data should be created through a separate analysis, incurring much cost and taking much time. In addition, because each software to be tested needs a separate test program, a problem arises in terms of the expense and time.

### SUMMARY OF THE INVENTION

The present invention has been made in view of the above-mentioned problem, and it is an object of the invention to provide a software test system and a software test method capable of improving characteristics in terms of time and costs, and a computer-readable recording medium having a program stored thereon for executing the method.

Another object of the invention is to provide a software test system and a software test method capable of improving reliability of testing, and a computer-readable recording medium having a program stored thereon for executing the method.

Still another object of the present invention is to provide a software test system and a software test method capable of being effectively applied for an embedded system, and a computer-readable recording medium having a program stored thereon for executing the method.

In one aspect, a software test system includes: a terminal device in which software to be tested (test-target software) is installed; and a software test device that stores a test driver for testing the test-target software according to test data and a test procedure of the test-target software, wherein the test driver is transmitted to the terminal device and tests the test-target software by combining the test data and the test procedure within the terminal device.

A single test driver may be provided, and the terminal device may run multiple test cases obtained by combining the test data and the test procedure by means of the single test driver.

The software test device may further include a test result information providing unit that provides information about the test results.

The information about the test results may be provided in at least one format of HTML, MS WORD, and MS Excel.

The test data and the test procedure may be created according to internal information of the test-target software, and the internal information of the test-target software may include information about an API (Application Program Interface) and information about a data type of variables.

The test data may include a variable data type partition that designates a range of values to be tested by data type of the variables, and an API variable partition that designates a range of values to be tested by variables included in an API based on the variable data type partition and the information about the API.

The test procedure may be test scripts that designate a call order with respect to the API and functions included in the API and the relationship among the calls.

The test driver may include a test oracle function (test result inspecting function) that inspects the test results.

The software test device may further include: an error information display unit that displays information about an error of the test-target software.

In another aspect, a software test method includes: a test data creating step of creating test data according to internal information of software to be tested (test- target software); a test procedure creating step of creating a test procedure of functions included in the test-target software according to the internal information of the test-target software; and a test driver creating step of creating a test driver according to the combination of the test data and the test procedure.

A single test driver may be provided, which may run multiple test cases obtained by combining the test data and the test procedure.

The soft test method may further include: a test result information providing step of providing information about the test results.

The information about the test results may be provided in at least one format of HTML, MS WORD, and MS Excel.

The internal information of the test-target software may include information about an API and information about a data type of variables.

The test data creating step may include: a variable data type partition creating step of creating a variable data type partition that designates a range of values to be tested by data type of the variables; and an API variable partition creating step of creating an API variable partition that designates a range of values to be tested by variables included in the API based on the variable data type partition and the information about the API.

In the test procedure creating step, a test script may be created to designate a call order with respect to the API and functions included in the API and a relationship among calls.

The test driver may include a test oracle function (test result inspecting function) for inspecting the test results.

The software test method may further include: an error information display step of displaying information about an error of the test-target software.

The computer-readable recording medium according to an embodiment of the present invention stores a program for executing the software test method according to the embodiment of the present invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings

FIG. 1 is a view illustrating the configuration of a software test system according to an embodiment of the present invention.

FIG. 2 is a view illustrating the results of extracting internal information of a test-target software.

FIG. 3 is a view showing a call graph representing call relationships among functions included in the test-target software.

FIG. 4 is a view illustrating a control flow graph (CFG) of the test-target software.

FIG. 5 is a view illustrating variable data type partition creation results.

FIG. 6 is a view illustrating API variable partition creation results.

FIG. 7 is a view illustrating test script creation results.

FIG. 8 is a view illustrating test driver creation results.

FIG. 9 is a view illustrating test program creation results.

FIG. 10 is a view illustrating test results.

FIG. 11 is a view illustrating information about an error.

FIG. 12 is a flow chart illustrating the process of a software test method according to an embodiment of the present invention.

### DETAILED DESCRIPTION OF THE INVENTION

Exemplary embodiments of the present invention will now be described in detail with reference to the accompanying drawings.

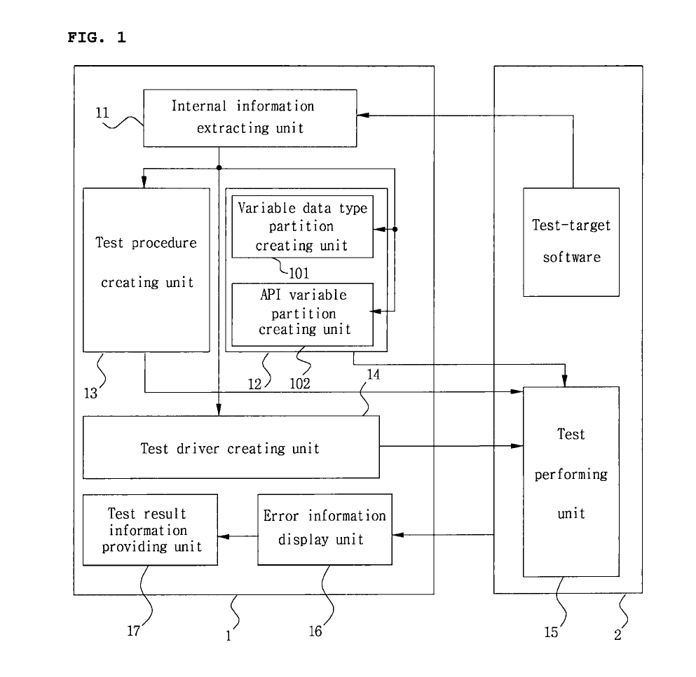

FIG. 1 is a view illustrating the configuration of a software test system according to an embodiment of the present invention.

As shown in FIG. 1, the software test system according to an embodiment of the present invention may include a software test device 1, a terminal device 2, and a signal transmission unit.

The software test device 1 may include an internal information extracting unit 11, a test data creating unit 12 that includes a variable data type partition creating unit 101 and an API variable partition creating unit 102, a test procedure creating unit 13, a test driver creating unit 14, a test performing (running) unit 15, an error information display unit 16, and a test result information providing unit 17.

<The Internal Information Extracting Unit 11>

The internal information extracting unit 11 may analyze a source code of a software to be tested (referred to as ‘test-target software’, hereinafter) to extract internal information of the test-target software.

In the following description, a case where the source code of the test-target software is created in a ‘C’ language will be taken as an example. However, the present invention may be also applicable for a case where the source code is created in a ‘C++’ or JAVA language.

In general, due to complexity in configuration, systems are structured, layered and developed as divided modules according to functions. When the function of a first module is supposed to be provided to a second module (in this case, the first module is defined as an internal module and the second module is defined as an external module, for the sake of convenience), the internal module provides a series of APIs to provide functions of the internal module to the external module. The external module is developed by using the provided APIs regardless of a substantial internal configuration of the internal module. Namely, at the side of the external module, if the function of the internal module properly operates, it means that the function of the APIs properly operates.

The software test system according to the embodiment of the present invention is based upon such recognition, in which software is tested based on the APIs for an optimum software testing.

However, in the conventional sequential programming language such as ‘C’ language, there is no information for discriminating the APIs and other functions than the APIs in a source code.

In this case, in order to effectively run software testing, the internal information extracting unit 11 analyzes a source code of the test-target software to determine APIs that are subject to testing. For this purpose, the internal information extracting unit 11 uses the call relationship among functions. Namely, a function which is not called by other functions is interpreted as an API that can be accessed from outside. In this case, however, a case where a function is called by a function main ( ) is not counted. Namely, a function which is not called by other functions than the function main ( ) can be selected as an API.

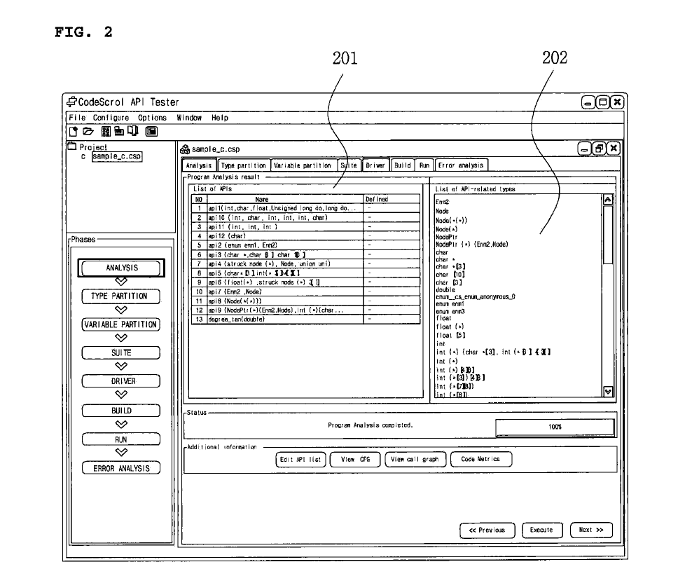

FIG. 2 is a view illustrating the results of extracting internal information of a test-target software.

With reference to FIG. 2, information about APIs and general functions, not the APIs, and information about variable data type are displayed.

The APIs are defined as functions which are not called by other functions than the function main ( ), and the general functions are defined as functions which are not the API.

With reference to a function information display window 201, twelve APIs including api1 to api12 and a general function degree_tan( ) are displayed.

In addition, as for a variable data type information display window 202, variable data types such as Enm2, Node, etc., are displayed.

The internal information extracting unit 11 analyzes the source code of the test-target software and extracts the call relationship among functions included in the test-target software.

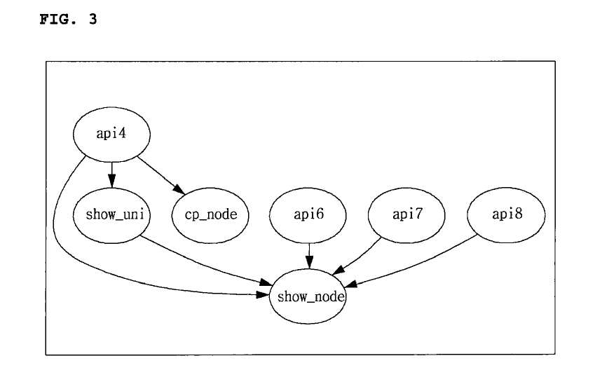

FIG. 3 illustrates a call graph showing the call relationships among functions included in the test-target software.

With reference to FIG. 3, the call relationships among api4, api6, api7, and api8, the API functions, and show_uni, cp_node, and show_node, the general functions, are shown.

As noted in FIG. 3, when the test-target software is tested with the APIs as a target, the test-target software can be more finely and minutely tested. This will now be described in detail by taking a case where api4 is tested as an example. Namely, when api4 is tested, 1) show_uni or cp_node is called and tested according to a function parameter of api4, and when show_uni is called, show_node is accordingly called, thus automatically testing the test-target software throughout; and 2) a function call path in which the test-target software is run in an actual environment can be tested, so the testing can be effectively performed (run).

In addition, the internal information extracting unit 11 analyzes the source code of the test-target software to create a CGF of the test-target software.

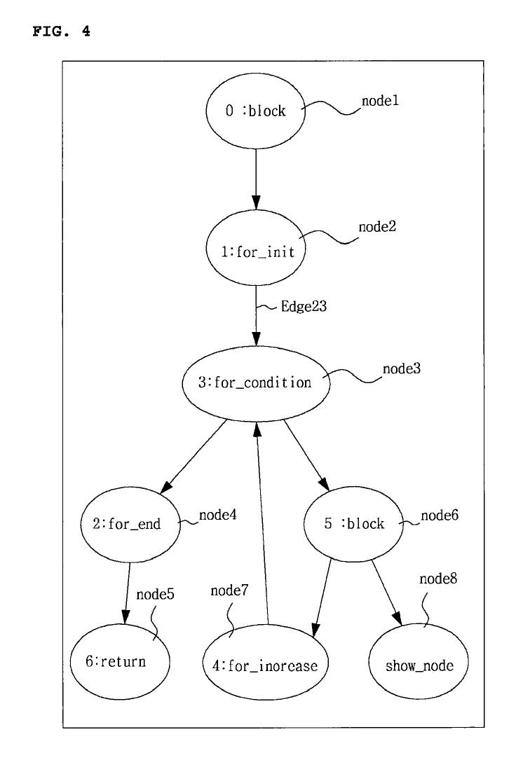

FIG. 4 is a view illustrating the control flow graph (CFG) of the test-target software.

With reference to FIG. 4, a control structure within functions is shown as a control flow among blocks. Nodes of the CFG indicate program blocks and edges, the lines connecting the nodes, indicate the performing order between blocks.

The internal information extracting unit 11 writes (marks) a unique number at each node, and description for a type of each node is also written beside the node numbers. For example, a second node (node2) is written as 1:for_init, in which 1 indicates the unique number of the second node (node2) and for_init is the description of the type of the second node (node2).

An out-node corresponds to a start point of an edge, and an in-node corresponds to an end point of the edge. If the two nodes are connected via the single edge, when performing a block corresponding to the out-node is completed, performing a block corresponding to the in-node starts. For example, in case of edge 23, the second node (node2) is the out-node and the third node (node3) is the in-node. In this case, when performing the block corresponding to the second node (node2) is completed, performing the block corresponding to the third node (node3) starts.

Besides the control flow within the function, a function call is additionally defined in the CFG. An eighth node (node8) indicates a function, and FIG. 4 shows that a fifth block corresponding to the sixth node (node6) calls the function show_node.

<The test data creating unit 12>

The test data creating unit may include the variable data type partition creating unit 101 and the API variable partition creating unit 102.

The variable data type partition creating unit 101 creates a variable data type partition that designates a range of values to be tested by data type of variables included in the test-target software.

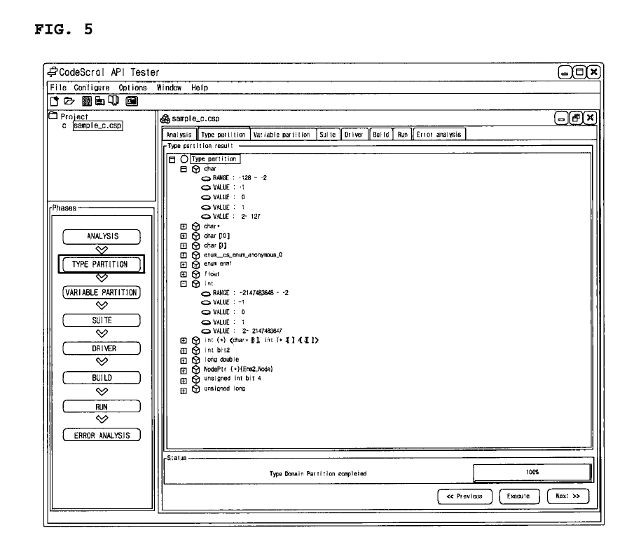

FIG. 5 is a view illustrating variable data type partition creation results.

With reference to FIG. 5, a range of values to be tested is designated by data type of variables included in the test-target software, so partitions (test division regions) are created by data type of the variables included in the test-target software.

The partitions may have the following types.

1) Range type partition

A range of values that a corresponding data type may have is partitioned by region and indicated.

For example, in case of Int, the range of −2147483648˜2147483647 is partitioned into the range of −2147483648˜−2 and the range of 2˜2147483647.

2) Value-list type partition

One or more particular values that a corresponding data type may have are arranged. Each value may have an arithmetic value or a character string value. For example, in case of Int, values −1, 0, and 1 are enumerated.

The API variable partition creating unit 102 creates an API variable partition that designates a range of values to be tested by variables of the functions included in the APIs based on the variable data type partition and the information about the APIs.

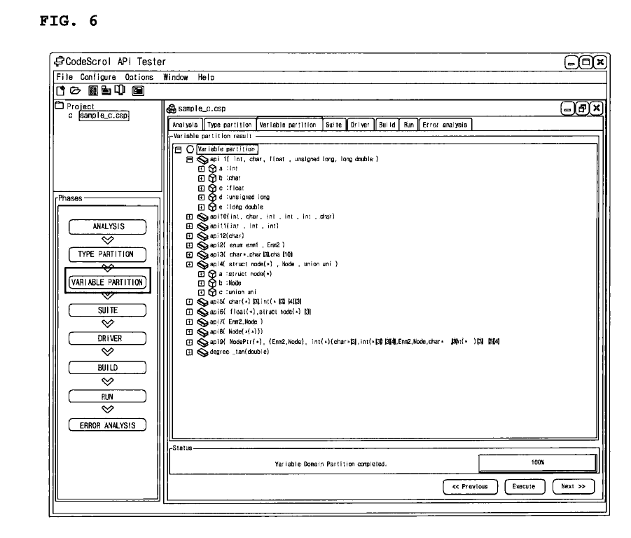

FIG. 6 is a view illustrating API variable partition creation results.

With reference to FIG. 6, it is noted that the range of values to be tested is designated by variables of the functions included in the APIs.

The API variable partition is created by combining data of the variable data type partition created by the variable data type partition creating unit 101 and data obtained by analyzing each API.

The API variable partition is created based on the variable data type partition and used to create test data with respect to the variables used in each API.

Although a range of values to be tested is not substantially shown in FIG. 6, but the range of values to be tested of the same variable included in each different API may differ. This will now be described by taking a case where int is included in both api1 and api10, as an example. Namely, although both api1 and api10 have int, respectively, the ranges of values to be tested used for api1 and api10 may be slightly different according to results obtained by analyzing api1 and api10, when provided. This is because the API variable partition analyzes what kind of values may affect the control flow within a function among various constant values present in the source code of the test-target software and automatically creates input values to be used for testing based on the analysis results.

<The Test Procedure Creating Unit 13>

The test procedure creating unit 13 creates test scripts designating a call order with respect to APIs and the functions included in the APIs, and the relationship among calls.

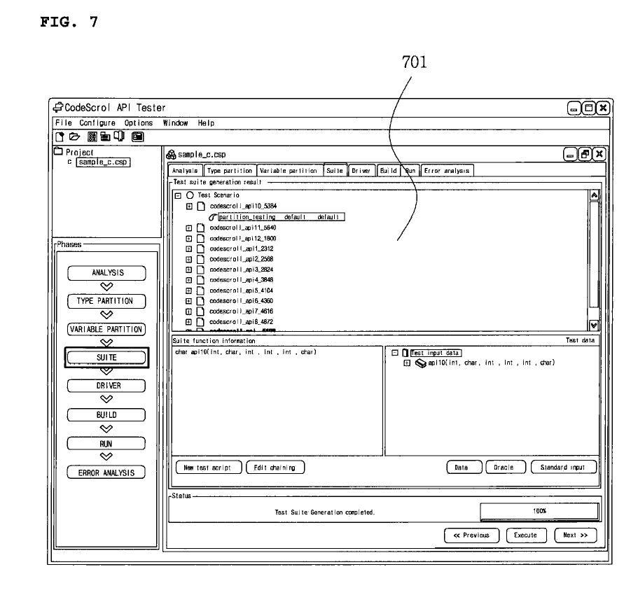

FIG. 7 is a view illustrating test script creation results.

With reference to FIG. 7, a single test script is basically created for each API, and those test scripts are displayed on a test script display window 701. If there is a dependence relationship according to the running order among functions registered on the API list, the test procedure creating unit 13 may also create a test script that includes several API calls in consideration of the running order of the corresponding functions. The test script may designate test input data to be combined with a script.

For example, a test script codescroll_api10_{—}5384 is made up of partition-testing default default. The partition-testing, namely, test data, is an input value to be used when a test program is performed (to be described). Such test data is automatically created by using the above-mentioned variable data type partition and the API variable partition.

<The Test Driver Creating Unit 14>

The test driver creating unit 14 may create a single test driver correspondingly according to the test data and the test script. The test driver may be stored in the software test device and transmitted to the terminal device 2 where the test-target software is installed through a signal transmission unit such as a serial cable, a USB (Universal Serial Bus) cable, etc.

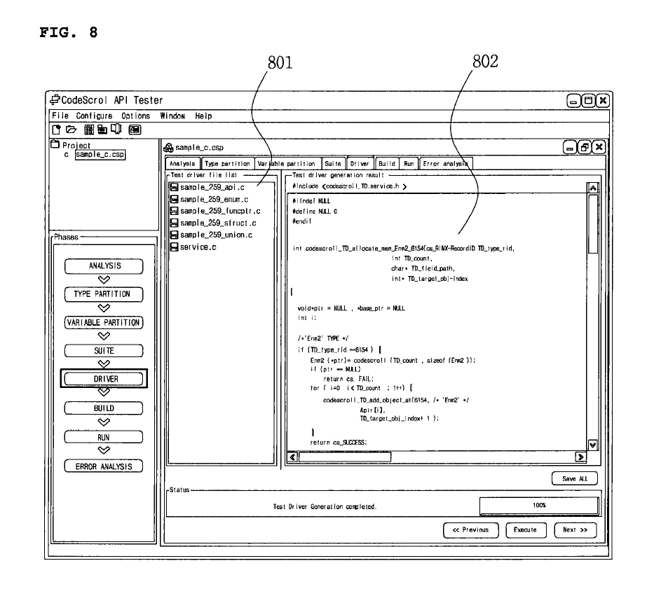

FIG. 8 is a view illustrating test driver creation results.

With reference to FIG. 8, a test driver file list for allowing operation of the test-target software by the test performing unit 15 (to be described) is displayed on a test driver display window 801, and a source code of the test driver is displayed on a test driver source code display window 802.

The test driver is a program allowing the test-target software to be operated by the test performing unit 15 and may be used when the test performing unit 15 creates data for use in the test-target software or calls the APIs provided by the test-target software, serving as the link between the test-target software and the test performing unit 15.

The test driver may include a test oracle function (test result inspecting function) for inspecting whether or not the test performing results with respect to the test-target software are proper, whereby whether or not the test performing results with respect to the test-target software have an error is automatically determined to inform the user accordingly.

<The Test Performing Unit 15>

The test performing unit 15 of the terminal device 2 may perform multiple test cases obtained by combining the test data and the test procedure by means of the single test driver, to test the test-target software.

For example, it is assumed, for example, that there are a hundred test data and a hundred test scripts. The combinations (multiplication) of the test data and the test scripts would create ten thousands test cases (100×100=10,000). Each test case is combined to the single test driver, and the test-target software is tested by the test driver to which respective test cases are combined. In the embodiment of the present invention, each test case is simply combined to the single test driver, and a test program is not generated for each test case. This will now be described in detail. In the related art software test systems, test programs are created for respective test cases, so the size of the overall test programs increases, which can be hardly applied for an embedded system. Comparatively, in the embodiment of the present invention, the software test system uses the single test driver, having the advantage that the size of the test program does not increase according to the number of test cases.

The terminal device 2 may include any terminal so long as it has operational software such as a wireless communication terminal, an electronic device establishing a ubiquitous environment, and the like.

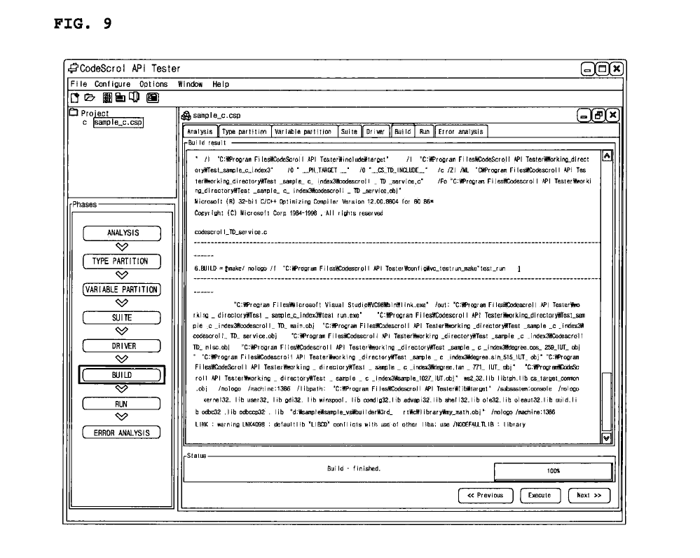

FIG. 9 is a view illustrating test program creation results.

With reference to FIG. 9, a test program created by combining the test data and the test script to the test driver is shown.

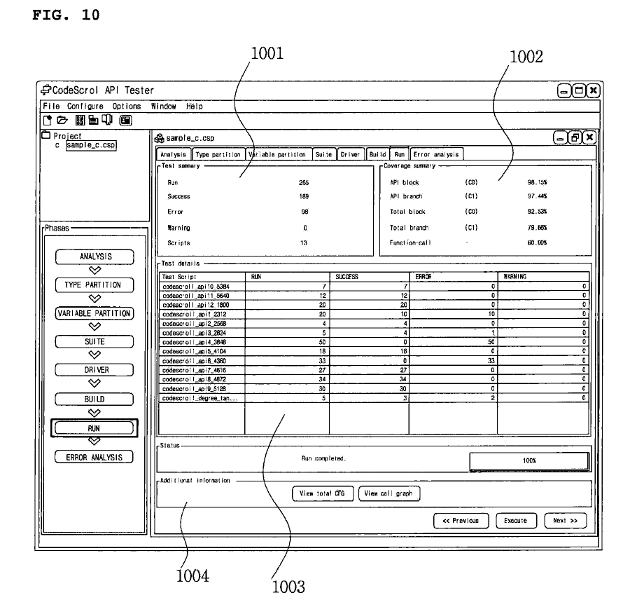

FIG. 10 is a view illustrating test results with respect to the test-target software.

With reference to FIG. 10, there are shown a test summary window 1001, a coverage summary window 1002, a test details window 1003, and an additional information window 1004.

1) The test summary window 1001 displays the number of test cases that have been run, the number of successful test cases, the number of failed test cases, the number of test cases that have caused warning, the number of used scripts, etc. 2) The coverage summary window 1002 displays coverage information achieved by running the overall test cases. A coverage achieved by an isolated test case is separately displayed. 3) The test details window 1003 displays the number of the entire test cases, the number of successful test cases, the number of failed test cases, and the number of test cases that have caused warning, of each script. 4) The additional information window 1004 displays a graph for showing which parts of the function CFG and the call graph have been run and how many times the corresponding parts have been run while the entire test cases are running.

<The Error Information Display Unit 16>

The error information display unit 16 displays information about an error of the test-target software, after the test-target software is tested.

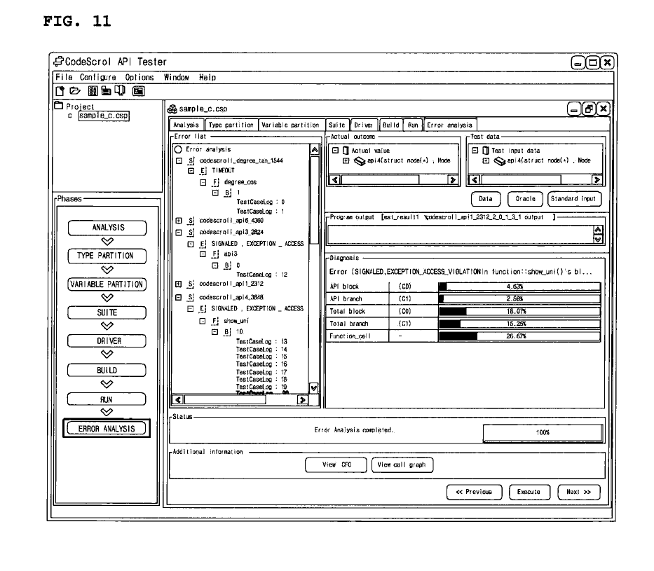

FIG. 11 is a view illustrating information about an error of the test-target software.

With reference to FIG. 11, errors of the test-target software are displayed in groups.

For example, the error information display unit 16 may display the error information by sorting the errors into 1) error-generated positions, 2) error-generated APIs, and 3) types of error messages.

<The Test Result Information Providing Unit 17>

The test result information providing unit 17 may create, store, and provide information about the test results of the test-target software.

The information about the test results of the test-target software may be provided in at least one format of HTML, MS WORD, and MS Excel.

In addition, the information about the test results of the test-target software may be created and provided in at least one of Korean, English and Japanese languages.

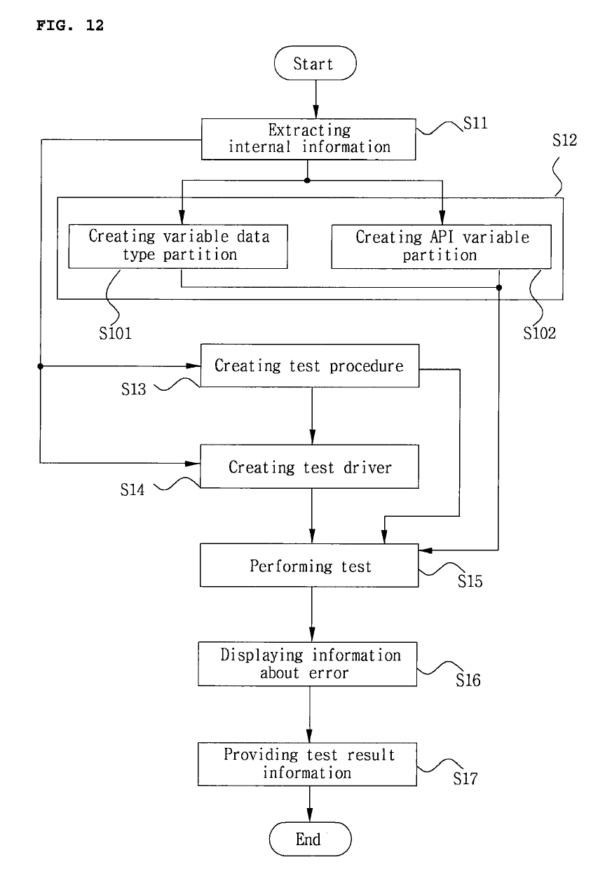

FIG. 12 is a flow chart illustrating the process of a software test method according to an embodiment of the present invention.

As shown in FIG. 12, the software test method according to the embodiment of the present invention may include an internal information extracting step (S11), a test data creating step (S12) including a variable data type partition creating step (S101) and an API variable partition creating step (S102), a test procedure creating step (S13), a test driver creating step (S14), a test running step (S15), an error information display step (S16), and a test result information providing step (S17).

<The Internal Information Extracting Step (S11)>

In the internal information extracting step (S11), internal information of the test-target software is extracted by analyzing the source code of the test-target software.

In the following description, a case where the source code of the test-target software is created in ‘C’ language, will be taken as an example. However, the present invention can be also applicable for a case where the source code is created in C++ or JAVA language.

In general, due to complexity in configuration, systems are structured, layered and developed as divided modules according to functions. When the function of a first module is supposed to be provided to a second module (in this case, the first module is defined as an internal module and the second module is defined as an external module, for the sake of convenience), the internal module provides a series of APIs to provide functions of the internal module to the external module. The external module is developed by using the provided APIs regardless of a substantial internal configuration of the internal module. Namely, at the side of the external module, if the function of the internal module properly operates, it means that the function of the APIs properly operates.

The software test method according to the embodiment of the present invention is based upon such recognition, in which software is tested based on the APIs for an optimum software testing.

However, in the conventional sequential programming language such as ‘C’ language, there is no information for discriminating the APIs and other functions than the APIs in a source code.

In this case, in order to effectively run software testing, in the internal information extracting step S11, a source code of the test-target software is analyzed to determine APIs that are subject to testing. For this purpose, the call relationship among functions is used. Namely, a function which is not called by other functions is interpreted as an API that can be accessed from outside. In this case, however, a case where a function is called by a function main ( ) is not counted. Namely, a function which is not called by other functions than the function main( ) can be selected as an API.

FIG. 2 is a view illustrating the results of extracting internal information of a test-target software.

With reference to FIG. 2, information about APIs and general functions, not the APIs, and information about variable data type are displayed.

The APIs are defined as functions which are not called by other functions than the function main ( ), and the general functions are defined as functions which are not the API.

With reference to a function information display window 201, twelve APIs including apil to api12 and a general function degree-tan( ) are displayed.

In addition, as for a variable data type information display window 202, variable data types such as Enm2, Node, etc., are displayed.

In the internal information extracting step S11, the source code of the test-target software is analyzed to extract the call relationship among functions included in the test-target software.

FIG. 3 illustrates a call graph showing the call relationships among functions included in the test-target software.

With reference to FIG. 3, the call relationships among api4, api6, api7, and api8, the API functions, and show_uni, cp_node, and show_node, the general functions, are shown.

As noted in FIG. 3, when the test-target software is tested with the APIs as a target, the test-target software can be more finely and minutely tested. This will now be described in detail by taking a case where api4 is tested as an example. Namely, when api4 is tested, 1) show_uni or cp_node is called and tested according to a function parameter of api4, and when show_uni is called, show_node is accordingly called, thus automatically testing the test-target software throughout; and 2) a function call path in which the test-target software is run in an actual environment can be tested, so the testing can be effectively performed.

In addition, in the internal information extracting step, the source code of the test-target software is analyzed to create a CGF of the test-target software.

FIG. 4 is a view illustrating the control flow graph (CFG) of the test-target software.

With reference to FIG. 4, a control structure within functions is shown as a control flow among blocks. Nodes of the CFG indicate program blocks and edges, the lines connecting the nodes, indicate the performing order between blocks.

A unique number is written (marked) at each node, and description for a type of each node is also written beside the node numbers. For example, a second node (node2) is written as 1:for_init, in which 1 indicates the unique number of the second node (node2) and for_init is the description of the type of the second node (node2).

An out-node corresponds to a start point of an edge, and an in-node corresponds to an end point of the edge. If the two nodes are connected via the single edge, when performing of a block corresponding to the out-node is completed, performing of a block corresponding to the in-node starts. For example, in case of edge 23, the second node (node2) is the out-node and the third node (node3) is the in-node. In this case, when performing of the block corresponding to the second node (node2) is completed, performing of the block corresponding to the third node (node3) starts.

Besides the control flow within the function, a function call is additionally defined in the CFG. An eighth node (node8) indicates a function, and FIG. 4 shows that a fifth block corresponding to the sixth node (node6) calls the function show_node.

<The Test Data Creating Step S12>

The test data creating step S12 may include the variable data type partition creating step S101 and the API variable partition creating step S102.

In the variable data type partition creating step S101, a variable data type partition that designates a range of values to be tested by data type of variables included in the test-target software, is created.

FIG. 5 is a view illustrating variable data type partition creation results.

With reference to FIG. 5, a range of values to be tested is designated by data type of variables included in the test-target software, so partitions (test division regions) are created by data type of the variables included in the test-target software.

The partitions may have the following types.

1) Range type partition

A range of values that a corresponding data type may have is partitioned by region and indicated.

For example, in case of Int, the range of −2147483648˜2147483647 is partitioned into the range of −2147483648˜−2 and the range of 2˜2147483647.

2) Value-list type partition

One or more particular values that a corresponding data type may have are arranged. Each value may have an arithmetic value or a character string value. For example, in case of Int, values −1, 0, and 1 are enumerated.

In the API variable partition creating step S102, an API variable partition, which designates a range of values to be tested by variables of the functions included in the APIs based on the variable data type partition and the information about the APIs, is created.

FIG. 6 is a view illustrating API variable partition creation results.

With reference to FIG. 6, it is noted that the range of values to be tested is designated by variables of the functions included in the APIs.

The API variable partition is created by combining data of the variable data type partition created in the variable data type partition creating step S101 and data obtained by analyzing each API.

The API variable partition is created based on the variable data type partition and used to create test data with respect to the variables used in each API.

Although a range of values to be tested is not substantially shown in FIG. 6, but the range of values to be tested of the same variable included in each different API may differ. This will now be described by taking a case where int is included in both api1 and api10, as an example. Namely, although both api1 and api10 have int, respectively, the ranges of values to be tested used for api1 and api10 may be slightly different according to results obtained by analyzing api1 and api10, when provided. This is because the API variable partition analyzes what kind of values may affect the control flow within a function among various constant values present in the source code of the test-target software and automatically creates input values to be used for testing based on the analysis results.

<The Test Procedure Creating Step S13>

In the test procedure creating step S13, test scripts designating a call order with respect to APIs and the functions included in the APIs, and the relationship among calls, are created.

FIG. 7 is a view illustrating test script creation results.

With reference to FIG. 7, a single test script is basically created for each API, and those test scripts are displayed on a test script display window 701. If there is a dependence relationship according to the running order among functions registered on the API list, a test script that includes several API calls in consideration of the running order of the corresponding functions may be created in the test procedure creating step S13. The test script may designate test input data to be combined with a script.

For example, a test script codescroll_api10_{—}5384 is made up of partition-testing default default. The partition-testing, namely, test data, is an input value to be used when a test program is performed (to be described). Such test data is automatically created by using the above-mentioned variable data type partition and the API variable partition.

<The Test Driver Creating Step S14>

In the test driver creating step S14, a single test driver is created correspondingly according to the test data and the test script. The test driver may be combined with results obtained by combining the test data and the test scripts (to be described), and the test-target software is tested according to such test driver.

FIG. 8 is a view illustrating test driver creation results.

With reference to FIG. 8, a test driver file list for allowing operation of the test-target software in the test performing step S15 is displayed on a test driver display window 801, and a source code of the test driver is displayed on a test driver source code display window 802.

The test driver is a program allowing the test-target software to be operated in the test performing step S15 and may be used when data for use in the test-target software is created or when the APIs provided by the test-target software is called. That is, the test driver serves as the link between the test-target software and the test performing step S15.

The test driver may include a test oracle function (test result inspecting function) for inspecting whether or not the test performing results with respect to the test-target software are proper, whereby whether or not the test performing results with respect to the test-target software have an error is automatically determined to inform the user accordingly.

<The Test Performing Step S15>

In the test performing step S15, multiple test cases obtained by combining the test data and the test procedure is run by means of the single test driver, to test the test-target software.

For example, it is assumed, for example, that there are a hundred test data and a hundred test scripts. The combinations (multiplication) of the test data and the test scripts would create ten thousands test cases (100×100=10,000). Each test case is combined to the single test driver, and the test-target software is tested by the test driver to which respective test cases are combined. In the embodiment of the present invention, each test case is simply combined to the single test driver, and a test program is not generated for each test case. This will now be described in detail. In the related art software test systems, test programs are created for respective test cases, so the size of the overall test programs increases, which can be hardly applied for an embedded system. Comparatively, in the embodiment of the present invention, the software test system uses the single test driver, having the advantage that the size of the test program does not increase according to the number of test cases.

FIG. 9 is a view illustrating test program creation results.

With reference to FIG. 9, a test program created by combining the test data and the test script to the test driver is shown.

FIG. 10 is a view illustrating test results with respect to the test-target software.

With reference to FIG. 10, there are shown a test summary window 1001, a coverage summary window 1002, a test details window 1003, and an additional information window 1004.

1) The test summary window 1001 displays the number of test cases that have been run, the number of successful test cases, the number of failed test cases, the number of test cases that have caused warning, the number of used scripts, etc. 2) The coverage summary window 1002 displays coverage information achieved by running the overall test cases. A coverage achieved by an isolated test case is separately displayed. 3) The test details window 1003 displays the number of the entire test cases, the number of successful test cases, the number of failed test cases, and the number of test cases that have caused warning, of each script. 4) The additional information window 1004 displays a graph for showing which parts of the function CFG and the call graph have been run and how many times the corresponding parts have been run while the entire test cases are running.

<The Error Information Display Step S16>

In the error information display step S16, after the test-target software is tested, information about an error of the test-target software is displayed.

FIG. 11 is a view illustrating information about an error of the test-target software.

With reference to FIG. 11, errors of the test-target software are displayed in groups.

For example, in the error information display step S16, the error information may be displayed by sorting the errors into 1) error-generated positions, 2) error-generated APIs, and 3) types of error messages.

<The Test Result Information Providing Step S17>

In the test result information providing step S17, information about the test results of the test-target software is created, stored, and provided.

The information about the test results of the test-target software may be provided in at least one format of HTML, MS WORD, and MS Excel.

In addition, the information about the test results of the test-target software may be created and provided in at least one of Korean, English and Japanese languages.

The computer-readable recording medium according to an embodiment of the present invention stores a program for executing the software test method according to the embodiment of the present invention as described above.

The computer-readable recording medium according to the embodiment of the present invention may include any types of recording devices so long as they can store data that can be read by a computer device. For example, the recording medium may be implemented in the form of a ROM, a RAM, a CD-ROM, a magnetic tape, a floppy disk, and an optical data storage device, or as carrier waves (e.g., transmission through the Internet). In addition, the computer-readable recording medium may store and execute codes that are distributed in computer devices connected through a network and read by a computer in a distributed manner.

Although the embodiments of the present invention have been disclosed for illustrative purposes, those skilled in the art will appreciate that various modifications, additions and substitutions are possible, without departing from the scope of the invention. Accordingly, the embodiments of the present invention are not limited to the above-described embodiments, but are defined by the claims which follow, along with their full scope of equivalents.

As described above, the software test system, the software test method, and the computer-readable recording medium having a program stored thereon for executing the method can allow a test-target program to be tested within a short time at a relatively low cost.

In addition, the reliability of testing the test-target program can be improved.

Moreover, the present invention can be effectively applicable for an embedded system.

What is claimed is:

1. A software test system comprising:
a terminal device in which software desired to be tested is installed; and
a software test device that stores a test driver for testing the test-target software according to test data and a test procedure of the test-target software, wherein the test driver is transmitted to the terminal device and tests the test-target software by combining the test data and the test procedure within the terminal device.

2. The system of claim 1, wherein the terminal device runs multiple test cases obtained by combining the test data and the test procedure by means of a single test driver.

3. The system of claim 2, wherein the software test device comprises a test result information providing unit that provides information about the test results.

4. The system of claim 3, wherein the information about the test results is provided in at least one format of HTML, MS WORD, and MS Excel.

5. The system of claim 2, wherein the test data and the test procedure are created according to internal information of the test-target software, and the internal information of the test-target software comprises information about an API (Application Program Interface) and information about a data type of variables.

6. The system of claim 5, wherein the test data comprises:
a variable data type partition that designates a range of values to be tested by data type of the variables; and
an API variable partition that designates a range of values to be tested by variables included in an API based on the variable data type partition and the information about the API.

7. The system of claim 6, wherein the test procedure refer to test scripts that designate a call order with respect to the API and functions included in the API and the relationship among the calls.

8. The system of claim 2, wherein the test driver comprises a test oracle function that inspects the test results.

9. The system of claim 2, wherein the software test device further comprises:
an error information display unit that displays information about an error of the test-target software.

10. A software test method comprises:
a test data creating step of creating test data according to internal information of software desired to be tested;
a test procedure creating step of creating a test procedure of functions included in the test-target software according to the internal information of the test-target software; and
a test driver creating step of creating a test driver according to the combination of the test data and the test procedure.

11. The method of claim 10, wherein a single test driver is provided, and multiple test cases obtained by combining the test data and the test procedure are run by using the single test driver.

12. The method of claim 11, further comprising:
a test result information providing step of providing information about the test results.

13. The method of claim 12, wherein the information about the test results is provided in at least one format of HTML, MS WORD, and MS Excel.

14. The method of claim 11, wherein the internal information of the test-target software comprises information about an API and information about a data type of variables.

15. The method of claim 14, wherein the test data creating step comprises:
a variable data type partition creating step of creating a variable data type partition that designates a range of values to be tested by data type of the variables; and
an API variable partition creating step of creating an API variable partition that designates a range of values to be tested by variables included in the API based on the variable data type partition and the information about the API.

16. The method of claim 15, wherein, in the test procedure creating step, a test script is created to designate a call order with respect to the API and functions included in the API and a relationship among calls.

17. The method of claim 11, wherein the test driver comprises a test oracle function for inspecting the test results.

18. The method of claim 11, further comprising:
an error information display step of displaying information about an error of the test-target software.

19. A computer-readable recording medium a program stored thereon for executing the software test method of claims 10.
